(19) United States
(12) Patent Application Publication
(10) Pub. No.: US 2005/0091437 A1
(43) Pub. Date: Apr. 28, 2005

(54) MULTI-FUNCTION UNIVERSAL SERIAL BUS WIRELESS BRIDGE

(76) Inventors: Hung-Chun Yang, Taipei (TW); Charles Tsai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,183

(22) Filed: Oct. 28, 2004

(30) Foreign Application Priority Data
Oct. 28, 2003 (TW) 92129876

(51) Int. Cl. G06F 13/36

(52) U.S. Cl. 710/313; 710/306

(57) ABSTRACT

A multi-function universal serial bus (USB) wireless bridge is provided. The bridge has the USB host function and the USB peripheral devices function to bridge the USB wire signals to the wireless signals. An on-the-go (OTG) unit or switch is used to select whether the bridge should operate the USB host function or the USB peripheral function according to the type of the USB controller, which can be convenient for users.

### CROSS-REFERENCE TO RELATED APPLICATION

This application claims the priority benefit of Taiwan application serial no. 92129876, filed Oct. 28, 2004.

### BACKGROUND OF THE INVENTION

1. Field of the Invention

The present invention relates to a universal serial bus (USB), and more particularly, to a multi-function USB wireless bridge.

2. Description of the Related Art

Universal serial bus (USB) is a connection interface used as peripheral devices for the apparatus, such as desk-top computers, lap-top computers and personal digital assistants (PDAs). With the hot-plug feature, the user can thereby freely and conveniently add or remove the peripheral devices. And, when the peripheral device is connected or removed, it can be automatically detected and desk-top computers, lap-top computers or PDAs are maintained under the normal operation. Accordingly, USB has been widely used in, for example, keyboards, mouse, network cards and printers. In addition, since the peripheral device uses the USB interface, with the convenience of adding and removing function for the computer peripheral devices, a storing device using USB interface has been thereby developed to conveniently transmit or share data between computers.

FIG. 1 is a schematic block diagram showing a conventional USB connecting system. With reference to FIG. 1, the computer with supporting USB usually comprises a USB host controller 110 for controlling USB peripheral devices, which have been connected to the USB host controller 110 via the USB connection cord. Wherein, the USB peripheral device 150 and the on-the-go (OTG) USB peripheral device 160 are directly coupled to the USB host controller 110. The USB peripheral devices 130 and 140 are further coupled to the USB host controller 110 via the USB hub 120. However, in any of the foregoing manners, the USB cords are used for connection.

For providing a using environment with user-friendliness, there are some USB peripheral devices in specific type using the wireless connection, but the wireless connection cannot be used in other type of USB peripheral devices. U.S. Pat. No. 5,890,015, titled “Method and apparatus for implementing a wireless universal serial bus host controller by interfacing a universal serial bus hub as a universal serial bus device”, discloses a wireless connection structure capable of use in different USB peripheral devices. However, different bridge devices are respectively required to connect the USB host controller to the USB peripheral devices, causing inconvenience to the users.

### SUMMARY OF THE INVENTION

Accordingly, the present invention is directed to a multi-function universal serial bus (USB) wireless bridge capable of bridging USB peripheral devices to the USB host controller by the wireless manner.

In order to achieve the object described above, the present invention discloses a multi-function USB wireless bridge suitable for bridging a wire signal of a USB to a wireless signal. The multi-function USB wireless bridge comprises a serial interface engine, a wireless transceiver, a USB host control unit, a USB peripheral unit, a first multiplexer and a second multiplexer. Wherein, the serial interface engine transmits and receives the wire signal of the USB. The wireless transceiver transmits and receives the wireless signal. The USB host control unit provides a control function for a USB host and a packet transformation between the wire signal and the wireless signal. The USB peripheral unit provides the function for a USB peripheral device and the packet transformation between the wire signal and the wireless signal. The first multiplexer is coupled to the serial interface engine, the USB host control unit and the USB peripheral unit. According to a selection signal, the first multiplexer selects a data transceiving route for the serial interface engine to the USB host control unit and the USB peripheral unit. The second multiplexer is coupled to the wireless transceiver, the USB host control unit and the USB peripheral unit. According to the selection signal, the second multiplexer selects a data transceiving route for the wireless transceiver to the USB host control unit and the USB peripheral unit.

In an embodiment of the present invention, the multi-function USB wireless bridge further comprises an on-the-go (OTG) unit coupled to the serial interface engine, the first multiplexer and the second multiplexer. According to a type of a USB control unit coupled to the serial interface engine, the OTG unit provides the foregoing selection signal. That is, when the serial interface engine is coupled to the USB host control unit, the selection signal controls the first and the second multiplexers to bridge the transceiving route between the serial interface engine and the wireless transceiver to the USB peripheral unit. When the serial interface engine is coupled to the USB peripheral control unit, the selection signal controls the first and the second multiplexers to bridge the transceiving route between the serial interface engine and the wireless transceiver to the USB host control unit. Wherein, the selection signal can be provided by a switch.

The present invention also provides a USB system using the multi-function USB wireless bridge described above. The USB system comprises a first USB controller, a first multi-function USB wireless bridge coupled to the first USB controller, a second USB controller and a second multi-function USB wireless bridge coupled to the second USB controller.

In an embodiment of the present invention, the first and the second multi-function USB wireless bridges can be connected to the USB host controller and the USB peripheral device, respectively. In another embodiment, the first and the second multi-function USB wireless bridges can be connected to the USB host controller and the USB hub, respectively. In still another embodiment, the first and the second multi-function USB wireless bridges can be connected to two USB host controllers for communication between different USB devices.

Therefore, single one of the multi-function USB wireless bridge in the present invention is capable of bridging the USB peripheral devices to the USB host controller, which is convenient in use for users.

The above and other features of the present invention will be better understood from the following detailed description of the embodiments of the invention that is provided in combination with the accompanying drawings.

### BRIEF DESCRIPTION OF THE DRAWINGS

FIG. 1 is a schematic block diagram showing a conventional USB connecting system.

FIG. 2 is schematic block diagram showing a USB connecting system according to an embodiment of the present invention.

FIG. 3 is schematic block diagram showing a multi-function USB wireless bridge according to an embodiment of the present invention.

### DESCRIPTION OF THE EMBODIMENTS

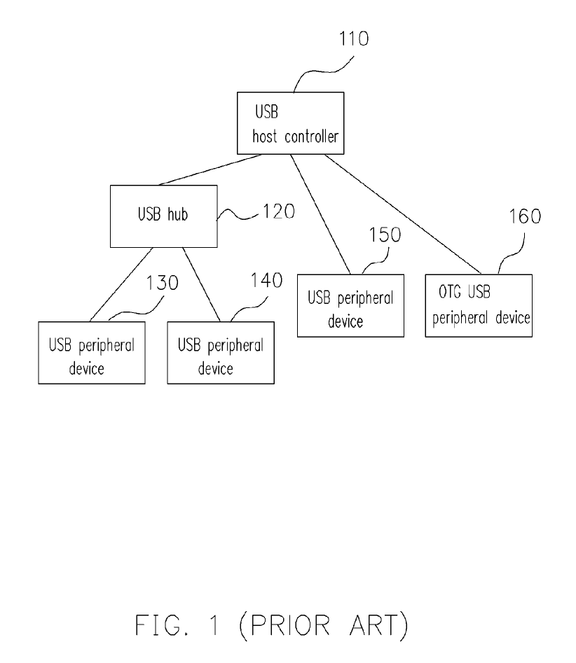

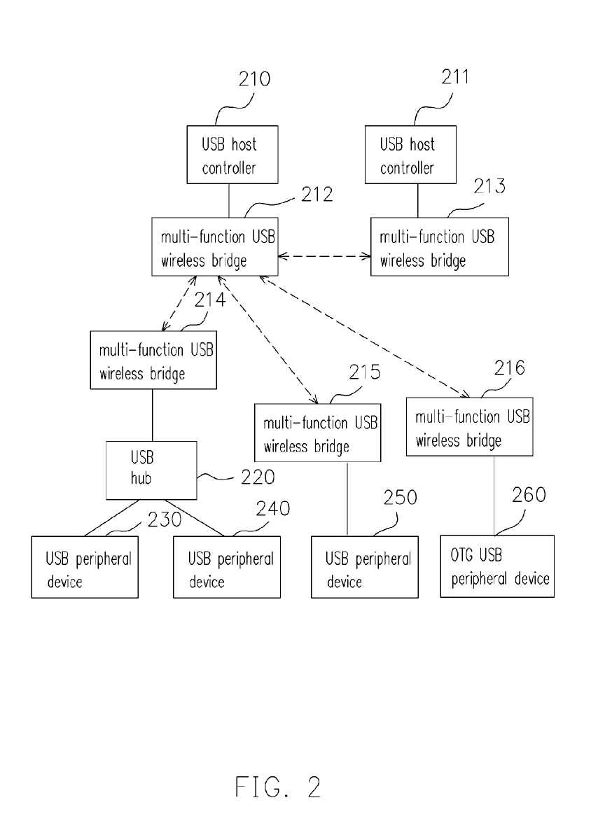

FIG. 2 is schematic block diagram showing a universal serial bus (USB) connecting system according to an embodiment of the present invention. Comparing with the structure in FIG. 1, the multi-function USB wireless bridges 212, 214, 215 and 216 are respectively used between the USB host controller 210 and the USB hub 220, between the USB host controller 210 and the USB peripheral device 250, and between the USB host controller 210 and the on-the-go (OTG) USB peripheral device 260, so as to bridge the USB wire signal being connected by the USB code to be a communication with a wireless signal manner. Under the USB protocol, the computer (not shown) having the USB host controller 210 is able to respectively communicate with the USB peripheral devices 230, 240 and 250 and the OTG USB peripheral device 260. Moreover, referring to FIG. 2, the USB system further comprises the USB host controller 211 implemented in another computer (not shown). The USB host controller 211 communicates with the computer having the USB host controller 210 via the USB wireless bridge 213. The communication, under this situation needs a driving software on the computers, respectively implemented with the USB host controller 210 and 211, specifically supplied for a USB communication between computers.

In FIG. 2, the solid lines represent USB cords. The dash lines between the multi-function USB wireless bridges 212, 213, 214, 215 and 216 represent they are wireless connection. Accordingly, the communication of the USB host controller 210 with the USB host controller 211, the USB hub 220, the USB peripheral device 250 and the OTG USB peripheral device 260 is performed via the USB wireless bridges 212, 213, 214, 215 and 216 to bridge the USB wire signals to the wireless signals. Therefore, the multi-function USB wireless bridges 212, 213, 214, 215 and 216 must simultaneously have function of the USB host control and function of the USB peripheral devices. The functions can be automatically selection by the USB connection, that is, the OTG protocol. For example, the multi-function USB wireless bridge 216 coupled to the OTG USB peripheral device 260 can automatically selects the operation in the host mode. Alternatively, the selection of the functions can be manual in selection by a switch. For example, the multi-function USB wireless bridges 212 and 213 are coupled to the USB host controllers 210 and 211, respectively. In this manner, the operation of the USB wireless bridges 212 and 213 should be set in the device mode. When the multi-function USB wireless bridges 214 and 215 are coupled to the USB hub 220 and the USB peripheral device 250, respectively, the operation of the USB wireless bridges 214 and 215 should be set in the host mode.

During the operation, the multi-function USB wireless bridges 212, 213, 214, 215 and 216 constitute a wireless network in a small scale. By using network identification, the wireless network packets can be transmitted to each other. In addition, the received wireless network packets can be transformed to the USB protocol packets for transmission. In order to meet the response delay requirement of the USB protocol, after receiving the USB protocol packets, the multi-function USB wireless bridges 212, 213, 214, 215 and 216 should respond an ACK/NACK packet to the USB bus. Although the present invention uses the relatively complicated system in FIG. 2 for descriptions, one of ordinary skill in the art should know that the present invention can also be separately used between the two terminals of a dash line in a simple system.

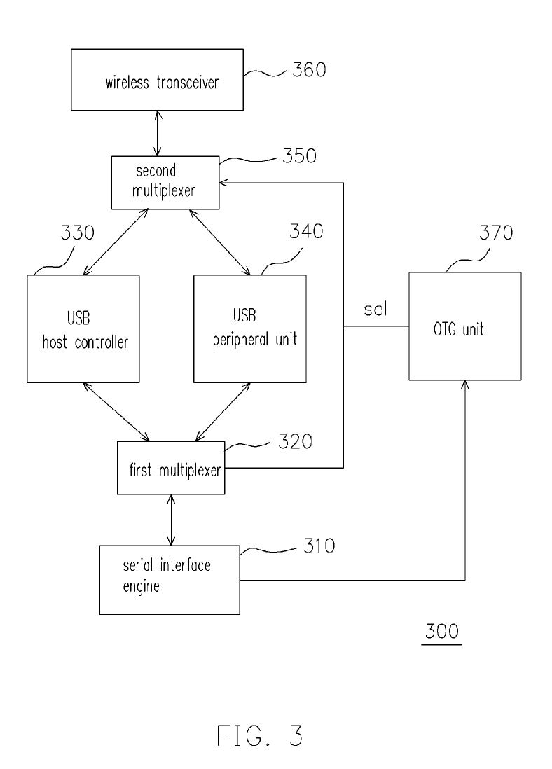

FIG. 3 is schematic block diagram showing a multi-function USB wireless bridge according to an embodiment of the present invention. As foregoing descriptions, the multi-function USB wireless bridge 300 has both the function for the USB host control and the USB peripheral devices. Accordingly, the multi-function USB wireless bridge 300 comprises the USB host control unit 330 and the USB peripheral unit 340 for respectively providing the function of the USB host control and function of the USB peripheral devices. In addition, the multi-function USB wireless bridge 300 also provide the function of packet transformation between the wire signals and the wireless signals.

The multi-function USB wireless bridge 300 also comprises the serial interface engine 310, the wireless transceiver 360, the first multiplexer 320, the second multiplexer 350 and the on-the-go (OTG) unit 370.

The serial interface engine 310 transceives the wire signal of the USB. The wireless transceiver 360 transceives the wireless signal being bridged. The OTG unit 370 is coupled to the serial interface engine 310, the first multiplexer 320 and the second multiplexer 350. According to the type of the USB controller coupled to the serial interface engine 310, the OTG unit 370 provides the selection signal sel.

The first multiplexer 320 is coupled to the serial interface engine 310, the USB host controller 330 and the USB peripheral unit 340. According to the selection signal sel provided by the OTG unit 370, the first multiplexer 320 selects a data transceiving route of the serial interface engine 310 to the USB host controller 330 or to the USB peripheral unit 340. The second multiplexer 350 is coupled to the wireless transceiver 360, the USB host controller 330 and the USB peripheral unit 340. According to the selection signal sel provided by the OTG unit 370, the second multiplexer 350 selects a data transceiving route between the wireless transceiver 360 and the USB host controller 330, or between the wireless transceiver 360 and the USB peripheral unit 340. One of ordinary skill in the art should know that the selection signal sel can be provided by a manual switch.

For example, when the serial interface engine 310 is like that the USB wireless bridge 212 is coupled to the USB host controller 210 as shown in FIG. 2, the selection signal sel controls the first and the second multiplexers 320 and 350 so as to bridge the transceiving route between the serial interface engine 310 and the wireless transceiver 360 to the USB peripheral device 340 and operate the USB peripheral device 340 function. When the serial interface engine 310 is like that the USB wireless bridge 215 is coupled to the USB peripheral device 250 as shown in FIG. 2, the selection signal sel controls the first and the second multiplexers 320 and 350 so as to bridge the transmission route between the serial interface engine 310 and the wireless transceiver 360 to the USB host controller 330 and operate the USB host controller 330 function. Therefore, the multi-function USB wireless bridge in the present invention is able to wireless bridge the USB peripheral devices to the USB host controller, which is convenient for users.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A multi-function universal serial bus (USB) wireless bridge adapted to bridge a wire signal of a USB to a wireless signal, the USB wireless bridge comprising:
a serial interface engine, for transceiving the wire signal;
a wireless transceiver, for transceiving the wireless signal;
a USB host controller, for providing a function for a USB host control and a packet transformation function between the wire signal and the wireless signal;
a USB peripheral unit, for providing a function for a USB peripheral device and a packet transformation function between the wire signal and the wireless signal;
a first multiplexer, coupled to the serial interface engine, the USB host controller and the USB peripheral unit, and according to a selection signal, selecting a data transceiving route for the serial interface engine to the USB host controller or the USB peripheral unit; and
a second multiplexer, coupled to the wireless transceiver, the USB host controller and the USB peripheral unit, and according to the selection signal, selecting a data transceiving route for the wireless transceiver to the USB host controller or the USB peripheral unit.

2. The USB wireless bridge of claim 1, further comprising an on-the-go unit coupled to the serial interface engine, the first multiplexer and the second multiplexer, and according to a type of a USB controller coupled to the serial interface engine, providing the selection signal.

3. The USB wireless bridge of claim 1, wherein the selection signal is provided by a switch.

4. A universal serial bus (USB) system, comprising:
a first USB controller;
a first multi-function USB wireless bridge, coupled to the first USB controller;
a second USB controller; and
a second multi-function USB wireless bridge, coupled to the second USB controller, wherein each of the first and the second multi-function USB wireless bridges comprises:
a serial interface engine, for transceiving a wire signal;
a wireless transceiver, for transceiving a wireless signal;
a USB host controller, for providing a function for a USB host control and a packet transformation function between the wire signal and the wireless signal;
a USB peripheral unit for providing a function for a USB peripheral device and a packet transformation function between the wire signal and the wireless signal;
a first multiplexer coupled to the serial interface engine, the USB host controller and the USB peripheral unit, and according to a selection signal, selecting a data transceiving route for the serial interface engine to the USB host controller or the USB peripheral unit; and
a second multiplexer coupled to the wireless transceiver, the USB host controller and the USB peripheral unit, and according to the selection signal, selecting a data transceiving route for the wireless transceiver to the USB host controller or the USB peripheral unit.

5. The USB system of claim 4, wherein each of the first multi-function USB wireless bridge and the second multi-function USB wireless bridge comprises an on-the-go unit coupled to the serial interface engine, the first multiplexer and the second multiplexer, and according to a type of a USB controller coupled to the serial interface engine, providing the selection signal.

6. The USB system of claim 4, wherein the selection signal is provided by a switch.

7. The USB system of claim 4, wherein the first USB controller is a USB host controller, and the second USB controller is a USB peripheral unit.

8. The USB system of claim 4, wherein the first USB controller is a USB host controller, and the second USB controller is a USB hub.

9. The USB system of claim 4, wherein the first USB controller and the second USB controller are USB host controllers.
